(19) United States
(12) Patent Application Publication
(10) Pub. No.: US 2025/0285855 A1
(43) Pub. Date: Sep. 11, 2025

(54) MULTIPLE FLOW PATH GAS INLET WITH INTEGRATED HEATING AND TEMPERATURE CONTROL

(71) Applicant: Inficon Inc., East Syracuse, NY (US)

(72) Inventor: Bob Cady, Syracuse, NY (US)

(73) Assignee: Inficon Inc., East Syracuse, NY (US)

(21) Appl. No.: 19/071,291

(22) Filed: Mar. 5, 2025

Related U.S. Application Data
(60) Provisional application No. 63/562,345, filed on Mar. 7, 2024.

(51) Int. Cl. H01J 49/04; H01J 49/42

(52) U.S. Cl. CPC H01J 49/0468; H01J 49/0422; H01J 49/4215

(57) ABSTRACT

A gas inlet includes a gas inlet chassis, an inlet sealingly disposed on an end of a process conduit and an outlet sealingly disposed on an exterior surface of a gas analyzer together with a plurality of gas paths connecting the inlet and the outlet with one or a plurality of heating elements rigidly thermally connected to the gas inlet chassis located such that the thermal distribution across the gas inlet chassis heats the gas flow through one or more gas paths. A method for providing heated gas to a mass spectrometer includes providing a gas inlet chassis that has a heating element and a plurality of gas paths disposed between an inlet and an outlet, directing an electrical current through a conduit into at least one heating element, and directing process gas through the outlet into a mass spectrometer.

### FIELD OF THE INVENTION

The present invention relates to residual gas analyzers (RGA) used for applications including, but not limited to, semiconductor and display manufacturing.

### BACKGROUND OF THE INVENTION

Residual gas analyzers (RGAs) play a multifaceted role in the semiconductor manufacturing domain. One of their primary functions lies in their ability to act as highly sensitive leak detectors. Semiconductor fabrication frequently involves a series of deposition and etching steps carried out within meticulously maintained vacuum chambers. Even the slightest breach in these chambers can lead to the intrusion of air, moisture, or other contaminants, potentially jeopardizing the intricate layers that form the basis of a semiconductor device. RGAs possess the capability to rapidly identify trace amounts of these unwanted gases, signaling the presence of a leak and prompting timely corrective measures. This safeguards precious time and resources, minimizing the risk of compromised batches of semiconductors.

In addition, RGAs are used to identify and monitor process contaminants in applications such as semiconductor and display fabrication processes. The fabrication of semiconductors often necessitates the use of reactive gases and chemical vapors as part of deposition, etching, and cleaning processes. RGAs are used to monitor residual gas composition within vacuum chambers, keeping track of the accumulation of these process gases or their byproducts. Such information provides a basis for chamber maintenance and cleaning cycles, and indicators for conditions indicating that a process step may not be performing as intended. Detecting such deviations is crucial for upholding product quality and ensuring the consistency of semiconductor devices.

The capabilities of RGAs extend into the realm of process optimization. By scrutinizing the evolution of gas compositions within vacuum chambers during a manufacturing process, engineers can glean a wealth of data. This data allows for the fine-tuning of critical parameters such as gas flow rates, the power levels used in plasma etching, or the timing of various process steps. The insights provided by RGAs empower manufacturers to boost their production yields while simultaneously enhancing the performance of the semiconductor devices they create.

Residual gas analyzers (RGAs) occupy a significant niche within the realm of analytical instrumentation, specifically in environments characterized by high and ultra-high vacuum conditions.

The initial step within an RGA involves the ionization of neutral gas molecules. In this process, a beam of electrons, typically generated via a thermionic emission filament, is accelerated towards the residual gas sample. Collisions between the energetic electrons and gas molecules result in the ejection of electrons from the gas molecules, yielding positively charged ions. The efficiency of the ionization process varies depending on the electron energy and the specific ionization cross-section of the gas species.

Following gas ionization, the RGA uses mass filtering to segregate ions according to their mass-to-charge ratio. Quadrupole mass filters represent the most widely utilized type of mass filter in RGAs. A quadrupole mass filter comprises four parallel cylindrical rods arranged in a square configuration. Radiofrequency (RF) and direct current (DC) voltages are superimposed on opposing pairs of rods, generating a complex oscillating electric field within the quadrupole assembly. Only ions possessing a specific m/z ratio will maintain a stable trajectory through the quadrupole filter under the influence of the applied voltages. By systematically varying the RF and DC voltages, the quadrupole can function as a mass spectrometer, sequentially allowing ions of different m/z ratios to pass through the filter.

Upon exiting the mass filter, ions impinge upon a detector. Faraday cups and electron multipliers are the two primary types of detectors used in RGAs. A Faraday cup operates on the principle of direct charge collection. Ions striking the Faraday cup induce a small electrical current, the magnitude of which is proportional to the abundance of the ions. Electron multipliers, on the other hand, utilize a series of dynodes to amplify the ion signal through secondary electron emission. This amplification process affords electron multipliers superior sensitivity compared to Faraday cups.

The output from the RGA detector is an electrical signal that fluctuates as a function of the scanned mass-to-charge ratios. This signal is amplified, digitized, and processed by a computer system. The resulting mass spectrum displays the relative abundance of ions as a function of their m/z ratio, providing a qualitative and quantitative fingerprint of the residual gas composition.

RGAs do not directly quantify pressure. Instead, they measure ion currents, which are correlated to the partial pressures of the constituent gases within the vacuum system. The sensitivity of an RGA is dependent on the ionization efficiency of different gas molecules, their transmission through the mass filter, and the detector's response.

Many gas analysis applications involve pressures too high for direct exposure to the quadrupole sensor. In that scenario, a pressure reduction system is required to reduce the inlet pressure and maintain the pressure at the quadrupole sensor at an operational level. With a pressure reduction system, a quadrupole sensor may be used for high pressure applications such as sputtering, chemical vapor deposition (CVD), etch, vacuum furnace analysis, and laser gas analysis.

A pressure reduction system is an orifice or a combination of an orifice and a capillary or sniffer to reduce the partial pressure of the gas-mixture at the process side, typically by a fixed proportion, with minimum mass discrimination. An orifice, a small disk with a defined radius hole, acts as a conductance limitation. When both the volume and the high vacuum pump speed are constant, the orifice hole size determines the magnitude of the pressure drop from the process pressure to the pressure at the sensor for proper operation.

Semiconductor process heats gas for process chemistry. If the hot gas enters the cold inlet, process byproducts can condense in the inlet or on the sensor. When sampling gases from certain semiconductor processes the gas sample needs to remain hot to prevent deposition or contamination to the inlet and sensor. Without a means for maintaining gas sample temperatures above a threshold, such unwanted deposition can clog flow paths and damage the sensor.

Current solutions use a heater jacket that wraps around the outside of the instrument. This leads to cold spots from both insufficient surface contact between the inlet and jacket, as well as unpredictable internal temperature variations due to the poor thermal conductivity of steel. Moreover, use of a heater jacket requires the dedication of space where the objective is to achieve compact RGA instrument designs. External heating jackets also use rubber compounds that can outgas and create particles that are undesirable in a clean room environment. Moreover, external heating jackets can have cold spots due to poor thermal conductivity of steel. Current technologies that utilize other solutions with internal heaters mounted on or in the gas inlet chassis only allow for heating only one gas flow path corresponding to one gas sample pressure.

As a result, there remains a need for gas inlet assembly designs that can ensure elevated temperatures are maintained for one or more gas paths through the gas inlet assembly controlled by inline gas valves. Such designs allow gas flows at different pressures through the RGA instrument and also provide for calibration with reference gas sources are desirable.

### SUMMARY OF THE INVENTION

To overcome the known drawbacks and achieve at least some of the stated objectives, an embodiment of the present invention provides a gas inlet assembly, including a gas inlet chassis, an inlet and an outlet disposed on the gas inlet chassis, a plurality of gas paths connecting the inlet and the outlet, and one or a plurality of heating elements thermally connected to the gas inlet chassis located such that the thermal distribution across the gas inlet chassis heats the gas flow through one or more gas paths.

In some embodiments, the gas inlet assembly further includes at least one of a low-pressure valve and a low-pressure gas path, a high-pressure valve and a high-pressure gas path, a high conductance valve and a high conductance gas path, a bypass pressure valve and a bypass pressure gas path, a calibration gas connection, a calibration pressure valve and a calibration gas path, or any combination thereof.

In certain embodiments, the gas flow through at least one gas path is controlled by a valve disposed along the gas path.

In some embodiments, the gas inlet assembly further includes a sensor disposed in contact with the gas inlet chassis and a controller to maintain the temperature of the gas flow through at least one gas path above a temperature setpoint.

In some embodiments, the gas inlet chassis may be made with carbon steel, mild steel, cast iron, wrought iron, a stainless steel such as a 300 series stainless steel or a 400 series stainless steel (e.g., 304, 316, or 439 stainless steel), Monel, Inconel, bronze, brass or a combination thereof.

Another embodiment of the present invention provides a residual gas analyzer including a mass spectrometer, a process gas inlet conduit, a gas inlet chassis sealingly disposed between the mass spectrometer and an end of the process gas inlet conduit, wherein the gas inlet chassis includes at least one heating element and a plurality of gas paths disposed between an inlet and an outlet, and wherein one or a plurality of heating elements thermally connected to the gas inlet chassis located such that the thermal distribution across the gas inlet chassis heats the gas flow through one or more gas paths.

A further embodiment of the present invention provides a gas inlet assembly for a residual gas analyzer including a gas inlet chassis, an inlet sealingly disposed on an end of a process conduit, an outlet sealingly disposed on an exterior surface of a gas analyzer, a plurality of gas paths connecting said inlet and said outlet, and one or a plurality of heating elements rigidly thermally connected to the gas inlet chassis located such that the thermal distribution across the gas inlet chassis heats the gas flow through one or more gas paths.

In some embodiments, the gas inlet assembly is detachably disposed on an exterior surface of a mass spectrometer using a gasket and seals said mass spectrometer in fluidic communication to a process inlet conduct. In additional embodiments, the gas inlet assembly is detachably disposed on an exterior surface of a mass spectrometer using a flange and a gasket rigidly attached using at least one fastener. In further embodiments, the gas inlet assembly is detachably disposed on an exterior surface of a process inlet conduit using a flange and seal rigidly attached using at least one fastener. The gasket may be made with an elastomer material.

In certain embodiments, the gas inlet chassis may include carbon steel, mild steel, cast iron, wrought iron, a stainless steel such as a 300 series stainless steel or a 400 series stainless steel (e.g., 304, 316, or 439 stainless steel), Monel, Inconel, bronze, and brass or a combination thereof.

Also disclosed is a method for providing heated gas to a mass spectrometer including providing a gas inlet chassis that includes at least one heating element and a plurality of gas paths disposed between an inlet and an outlet, directing a stream of gas under pressure into the inlet, directing an electrical current through a conduit into at least one heating element to generate a temperature gradient across the gas inlet chassis material, and directing the gas flow through the outlet into a mass spectrometer.

In some embodiments, the gas flow through at least one gas path is controlled by adjusting a valve disposed along said gas path.

Further disclosed is a method for measuring trace gases in a vacuum process including providing a mass spectrometer, providing a gas inlet chassis that includes at least one heating element and a plurality of gas paths disposed between an inlet and an outlet, directing a stream of gas under pressure from the process inlet conduit into the inlet, through the gas inlet assembly, and into the mass spectrometer, directing an electrical current through a conduit into at least one heating element to generate a temperature gradient across the gas inlet chassis material, and measuring the molecular species present in the gas using the mass spectrometer.

In some embodiments, the mass spectrometer is a quadrupole mass spectrometer.

The foregoing and other aspects, features, and advantages of the application will become more apparent from the following description and from the claims.

### BRIEF DESCRIPTION OF DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 illustrates the several components a fabrication process including a residual gas analyzer and a gas inlet assembly in accordance with one or more illustrative embodiments of the present invention.

FIG. 2 shows a perspective drawing of a residual gas analyzer including a gas inlet assembly in accordance with one or more illustrative embodiments of the present invention.

FIG. 3 illustrates a block diagram of a gas inlet assembly in accordance with one or more illustrative embodiments of the present invention.

FIG. 4 illustrates a longitudinal cross-sectional drawing of a gas inlet chassis in accordance with one or more illustrative embodiments of the present invention.

FIG. 5 illustrates horizontal cross-sectional drawing of a gas inlet chassis in accordance with one or more illustrative embodiments of the present invention.

FIG. 6 illustrates a longitudinal cross-sectional diagram of a gas inlet assembly in accordance with one or more illustrative embodiments of the present invention.

FIG. 7 illustrates a horizontal cross-sectional drawing of a gas inlet assembly in accordance with one or more illustrative embodiments of the present invention.

FIG. 8 illustrates an axial cross-sectional diagram of a gas inlet assembly in accordance with one or more illustrative embodiments of the present invention.

FIG. 9 illustrates longitudinal diagram exterior view of a gas inlet assembly in accordance with one or more illustrative embodiments of the present invention.

FIG. 10 illustrates a diagram of an exterior view of a residual gas analyzer manifold including a gas inlet assembly in accordance with one or more illustrative embodiments of the present invention.

FIG. 11 illustrates a longitudinal view of a gas flow valve in accordance with one or more illustrative embodiments of the present invention.

FIG. 12 illustrates a horizontal view of a gas flow valve gasket in accordance with one or more illustrative embodiments of the present invention.

FIG. 13 shows a plot of simulated data for the temperature distribution in a longitudinal cross-sectional diagram of a gas inlet assembly comprising a heating element disposed in the gas inlet chassis in accordance with one or more illustrative embodiments of the present invention.

FIG. 14 shows a plot of simulated data for the temperature distribution in a horizontal cross-sectional diagram of a gas inlet assembly comprising a heating element disposed in the gas inlet chassis in accordance with one or more illustrative embodiments of the present invention.

### DETAILED DESCRIPTION OF THE INVENTION

The inventors have surprisingly discovered that a heating element can be integrated in a gas inlet path assembly with multiple gas paths, thus eliminating the need for a heater jacket. Such an approach to gas inlet assembly design allows flexibility to sample multiple pressures by drawing gasses down different flow paths. In an embodiment, the gas inlet chassis can be heated by an integrated cartridge heater that is bored into the center of the inlet, this allowing the source of heat to be directly adjacent to the gas flow paths. Temperature measurements may be taken internal to the gas inlet chassis as well and the temperature can be controlled and monitored using a controller, thus reducing cold spots and ensures heat is delivered to optimize the production of heated gas samples to the mass spectrometer. Integrated control ensures the correct temperature, and the temperature can be changed depending upon the application.

Many gas phase fabrication and processing configurations benefit from the addition of a Residual Gas Analyzer (RGA) typically including a quadrupole mass spectrometer. As quadrupole gas analyzer technology becomes more affordable, RGAs are becoming commonplace in all industries that require strict control of contamination levels in process gases such as semiconductor and display processing. For example, in the semiconductor industry, RGAs are best used in evaporators, sputterers, etchers or any other high vacuum systems that are routinely pumped down to pressures below 10⁻⁵ Torr to check the integrity of the vacuum seals and the quality of the vacuum before any wafers are committed processing. Air leaks, virtual leaks and many other contaminants at very low levels can ruin wafers and must be detected before a process is started. As the semiconductor processes become more sophisticated, likewise the processes become less tolerant to contaminants. Residual gas analysis in a process chamber increases up-time and production yield and reduces cost of ownership.

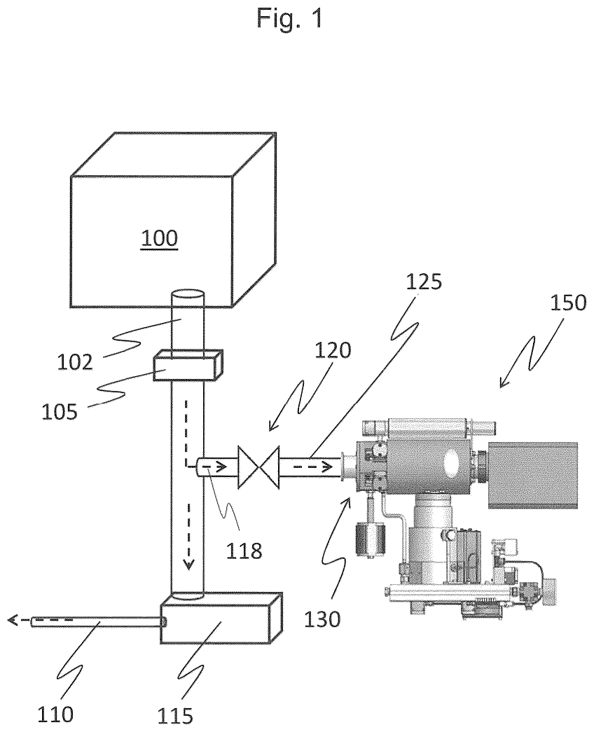

FIG. 1 shows an exemplary functional block diagram for a gas phase vacuum process incorporating a residual gas analyzer 150. The process chamber 100 is connected to the vacuum pump 115 by an exhaust conduit 102 that may include a throttle valve 105. Exhaust gas from the pump is delivered to an exhaust conduit 110 to a scrubber (not shown) to remove harmful pollutants from industrial exhaust gases before they are released into the atmosphere. A gas flow stream is diverted 118 to the RGA gas inlet conduit (equivalently, gas inlet conduit or inlet conduit) 125, possibly through one or more isolation valves 120. The diverted gas flow passes through a gas inlet assembly 130 into the residual gas analyzer instrument.

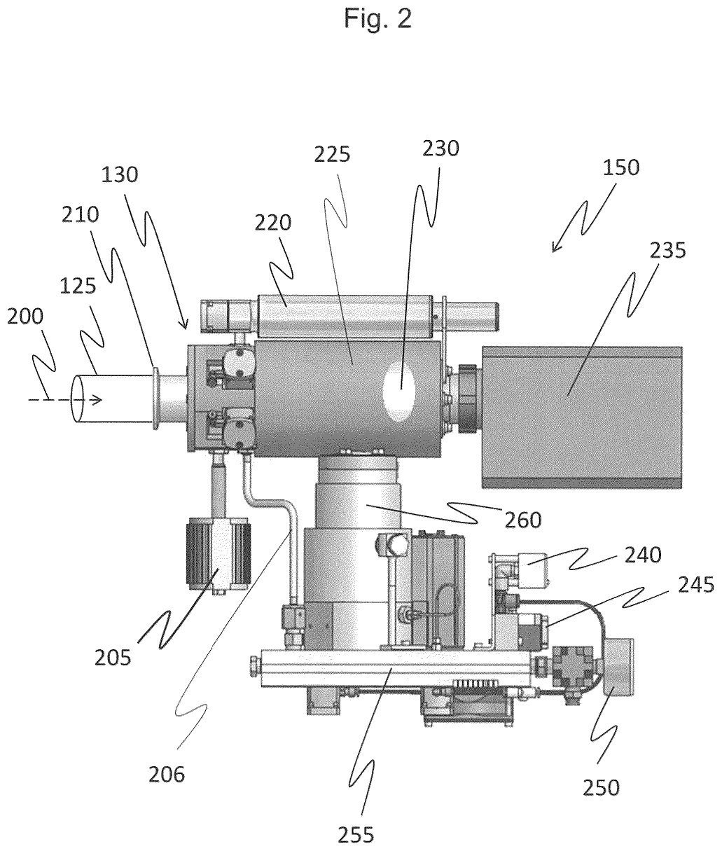

FIG. 2 shows a perspective drawing of an exemplary residual gas analyzer 150 including a gas inlet assembly in accordance with one or more illustrative embodiments of the present disclosure. Sample process gas flow 200 from the process chamber (not shown) is directed through the gas inlet conduit 125. The gas inlet conduit 125 is attached to the gas inlet assembly 130 by the process connector 210. Also attached to the gas inlet assembly 130 may be a process pressure gauge 205 (for example, a capacitance pressure gauge (CDG), an accurate temperature manometer), a calibration reference 220, and/or a bypass connection 206. Process sample gas flows through the gas inlet assembly 130 into the sensor manifold 230 which includes a compact process monitoring (CPM) emission sensor. In existing technology, the sensor manifold 230 may be encased by a heater jacket 225 to heat the gas flow indirectly through conduction and convection. The operation of the sensor and mass spectroscopy instrumentation is controlled and processed by the CPM electronics module 235. Gas flow is driven by a turbo molecular pump 260 controlled which may be controlled by dedicated embedded electronics in communication with the CPM electronics modules, in conjunction with a pressure switch 240, valve solenoids 245 that control the pneumatics on the gas inlet assembly, and a nitrogen regulator 250. The RGA is physically supported by an integrated foreline block 255.

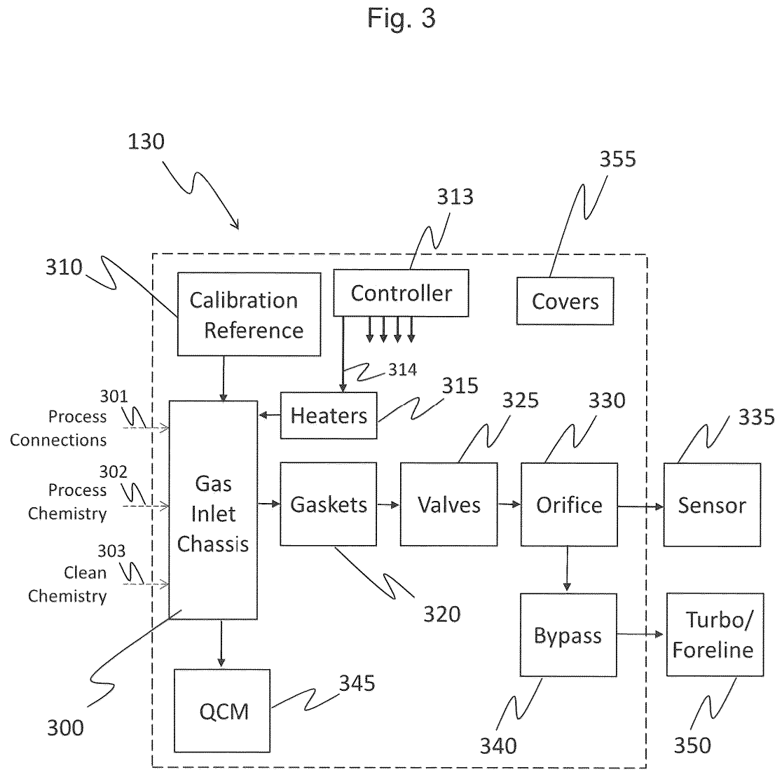

FIG. 3 shows a functional block diagram of an exemplary embodiment of a gas inlet assembly 130 including several key components. The gas inlet chassis 300 receives the process connections 301, the process chemistry 302 and the clean chemistry 303 through the gas flow entering the through the gas inlet conduit. The calibration reference 310 and the Quartz Crystal Microbalance (QCM) 345 operate through their flow connection to the gas path traversing the gas inlet chassis 300. The CPM mass spectrometer sensor 335 is in flow communication with the gas inlet chassis 300 through an assembly comprising gaskets 320, valves 325 and an orifice 330 designed to couple the gas flow and limit the pressure to the CPM sensor 335. The temperature of the gas path(s) may be managed using one or a plurality of heater(s) 315 managed by a controller 313 through an electrical connection 314, which may also control other RGA functions. The orifice 330 may also bleed gas flow to a bypass 340 to a vacuum pump 350, in some embodiments may be a diaphragm pump. In some embodiment, the gas inlet assembly may be protected by one or a plurality of covers 355.

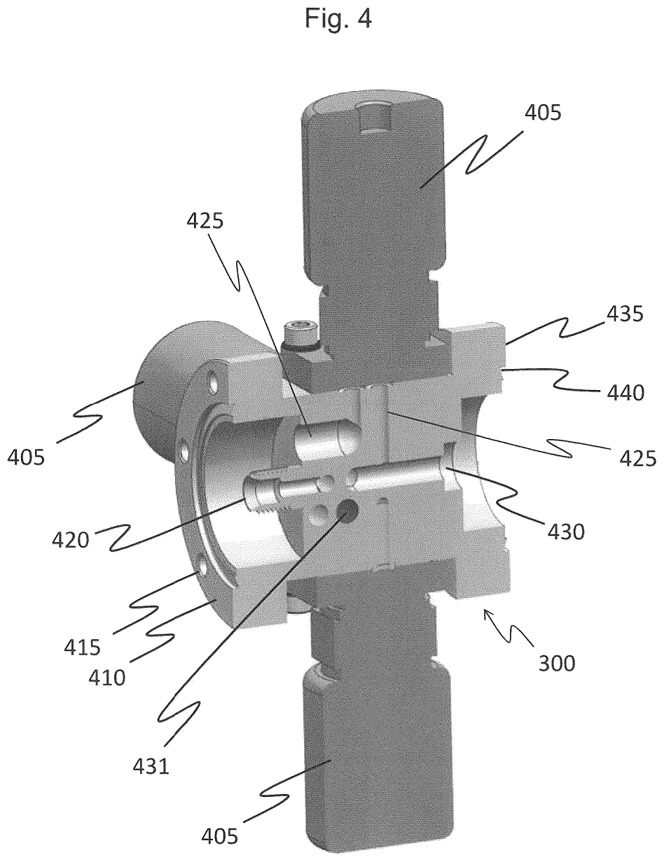

FIG. 4 illustrates a longitudinal cross-sectional drawing of an exemplary embodiment of a gas inlet chassis 300 in accordance with one or more illustrative embodiments of the present disclosure. In the exemplary embodiment shown, the gas inlet chassis 300 comprises an inlet flange 410 used to attach the gas inlet conduit (not shown) using the process connector (not shown) as described in FIG. 2. The process connector is held in place using a fastener (e.g., threaded bolt or equivalent) attached to the inlet flange 410 through a fastener hole 415 which may be threaded. Process gas enters the gas inlet chassis through a gas inlet nipple 420 (equivalently, gas inlet or inlet) where the flow may be separated and/or directed through one or a plurality of gas paths guided by gas path channels 425 in the gas inlet chassis 300 and controlled by gas valves 405. Receptacles for one or a plurality of heating elements (equivalently, heaters) 431 are fabricated into the gas inlet chassis 300. The process gas is directed out of the gas inlet chassis through a gas outlet orifice 430 (equivalently, gas outlet or outlet) to the sensor and measurement instrumentation. The gas inlet chassis is fixed to the sensor manifold using a fastener (e.g., threaded bolt or equivalent) attached to the outlet flange 435 through a fastener hole 440 which may be threaded

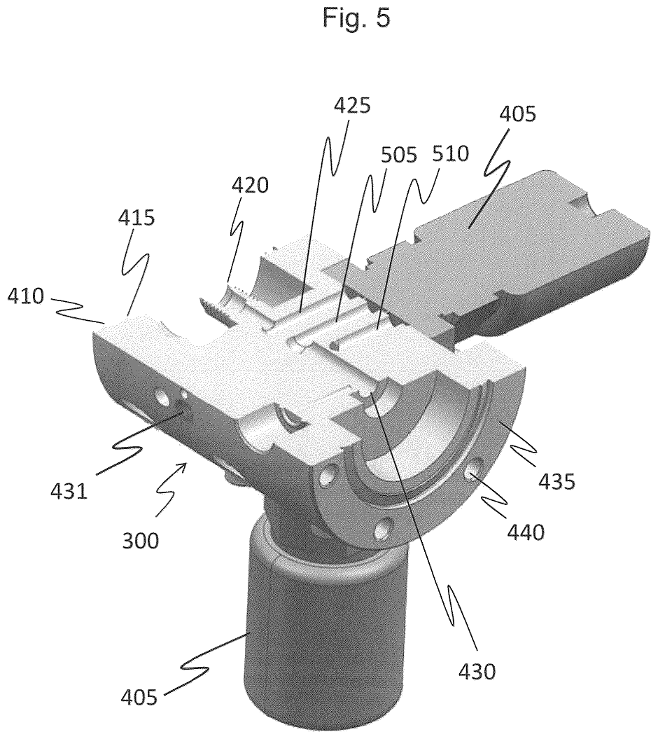

FIG. 5 illustrates horizontal cross-sectional drawing of a gas inlet chassis 300 in accordance with one or more illustrative embodiments of the present disclosure. In the exemplary embodiment shown, the gas inlet chassis 300 comprises an inlet flange 410 used to attach the gas inlet conduit (not shown) using the process connector (not shown) as described in FIG. 2. The process connector is held in place using a fastener (e.g., threaded bolt or equivalent) attached to the inlet flange 410 through a fastener hole 415 which may be threaded. Process gas enters the gas inlet chassis through a gas inlet nipple 420 (equivalently, gas inlet or inlet) where the flow may be separated and/or directed through one or a plurality of gas paths guided by gas path channels 425 in the gas inlet chassis 300. Receptacles for one or a plurality of heating elements (equivalently, heaters) 431 are fabricated into the gas inlet chassis 300. The process gas is directed out of the gas inlet chassis through a gas outlet orifice 430 (equivalently, gas outlet or outlet) to the sensor and measurement instrumentation. The gas inlet chassis is fixed to the sensor manifold using a fastener (e.g., threaded bolt or equivalent) attached to the outlet flange 435 through a fastener hole 440 which may be threaded.

FIG. 5 also illustrates the distinct gas paths fabricated into the gas inlet chassis used to separate the process gas flow into separate streams that can be controlled by separate gas valves 405 at distinct pressures governed by orifices of different sizes. Diverted process gas is directed through a gas path 505 that enters a gas valve 405 and exits through a channel 510 to be recombined to exit the gas inlet chassis 300 through the gas outlet orifice 430.

Gas paths 425 may be controlled by separate gas valves 405 and orifices serve a variety of instrumentation purposes. The gas paths, orifices and valves are designed to deliver process gas at possibly different pressures below atmospheric pressures (e.g., vacuum) suitable for different elements of the RGA instrument. TABLE 1 summarizes some of the purposes (not meant to be limiting) for supporting one or a plurality of gas paths through the gas inlet chassis.

TABLE 1

| | |
|---|---|
| V1 (LP) | Low pressure gas path controlled by low pressure |
| | valve |
| V2 (HP) | High pressure gas path controlled by high pressure |
| | valve |
| V3 (HC) | High conductance gas path controlled by high |
| | conductance valve - used if the sensor's process |
| | connection is under high vacuum |
| V4 (Bypass) | Bypass gas path controlled by bypass valve. Typically |
| | used in conjunction with high pressure gas path and |
| | valve |
| V5 (Calibration) | Calibration gas path controlled by calibration valve. |
| | Used if a calibration gas system is incorporated into |
| | the RGA |

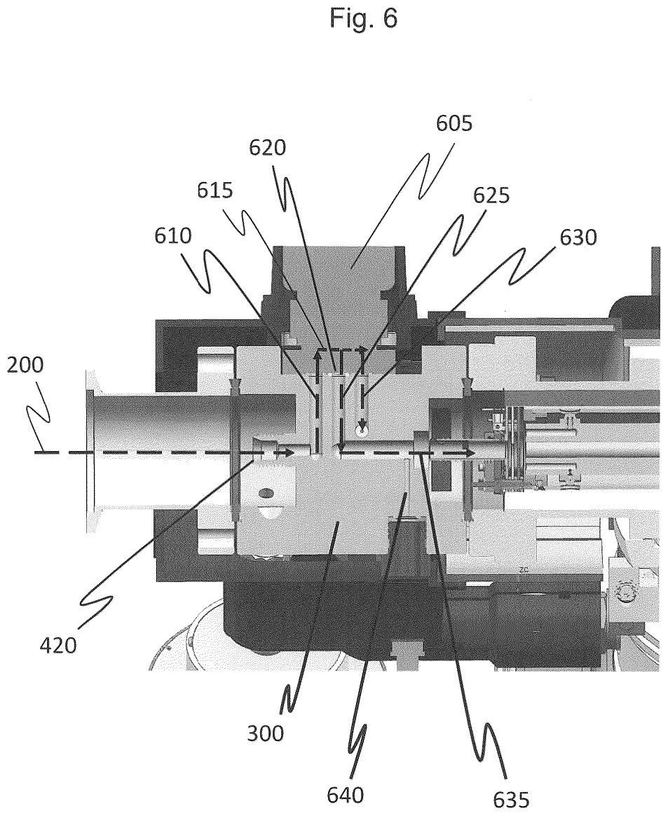

FIG. 6 illustrates a longitudinal cross-sectional diagram of an embodiment of a gas inlet assembly in accordance with one or more illustrative embodiments of the present disclosure. Process gas 200 enters the gas inlet assembly 300 through the gas inlet 420 nipple. Part of the gas flow is diverted to the high-pressure gas path 610 (V2 (HP) flow path) into the high-pressure valve 605. The gas flow is then directed along three gas paths: One gas path is directed 615 through an orifice 620 through the main body of the gas inlet chassis via valve exit gas path 625 and out the gas outlet orifice 635. A second gas path directs 630 to the bypass valve (not shown) (V4 (Bypass)). The third gas path directs process gas to the calibration gas path 640 (V5 (Calibration)).

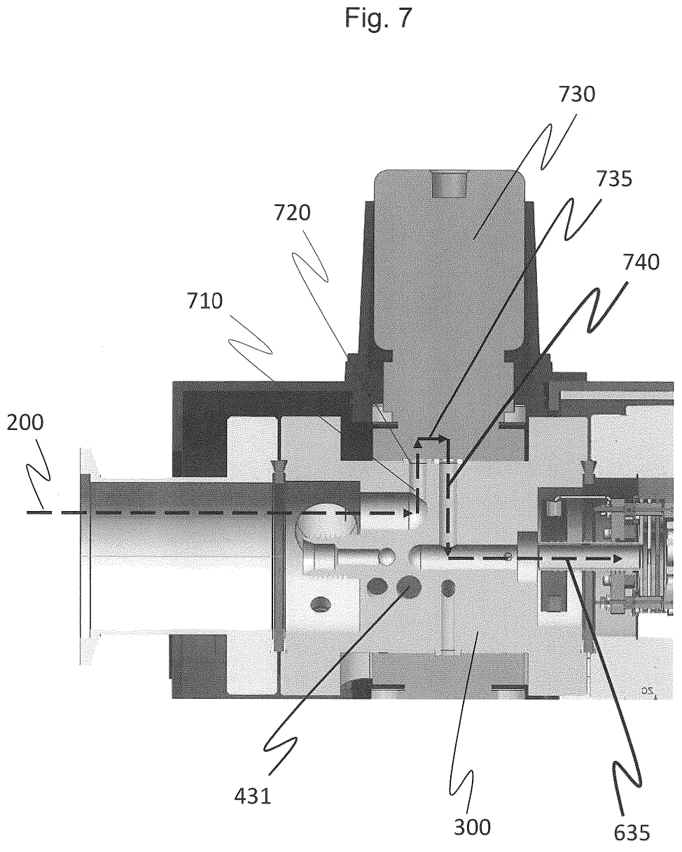

FIG. 7 illustrates a horizontal cross-sectional drawing of a gas inlet assembly in accordance with one or more illustrative embodiments of the present disclosure. Process gas 200 enters the gas inlet assembly 300 and partly diverted to the low-pressure gas path 710 (V1 (LP) flow path) through a pressure-limiting orifice 720 into the mechanism 735 of a low-pressure valve 730. The diverted gas stream is directed through a low-pressure return path 740 out the gas outlet orifice 635. Also visible is a receptacle 431 for an electrical heating element used to distribute thermal energy in the gas inlet chassis 300.

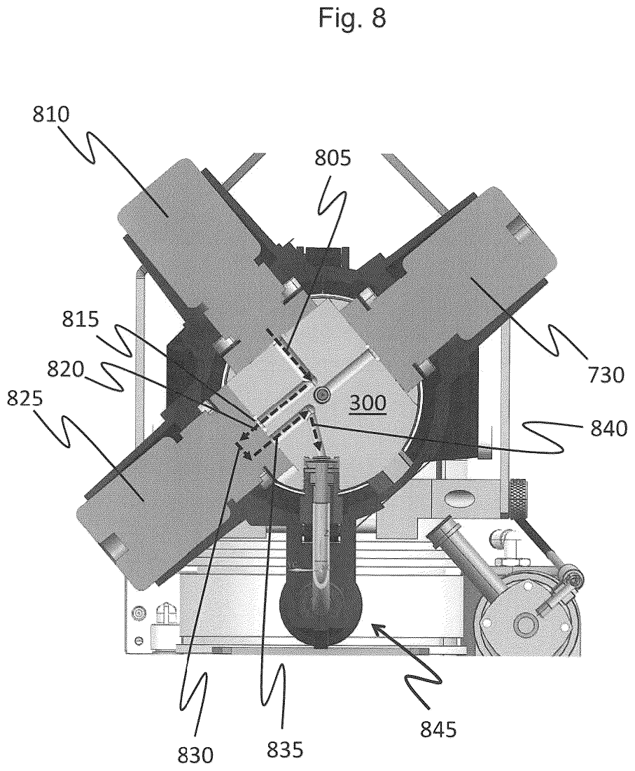

FIG. 8 illustrates an axial cross-sectional diagram of a gas inlet assembly in accordance with one or more illustrative embodiments of the present disclosure. Process gas that has entered the gas inlet chassis 300 through the gas inlet nipple (not shown) exits 805 the high-pressure valve 810 (V2 (HP)) and is partly diverted 820 through a bypass orifice 815 into a bypass valve 825 (V4) through the mechanism 830 of the bypass valve 825. The bypass gas path exits 835 the bypass valve 825 and is directed 840 to the turbo molecular pump (TMP) split flow bypass apparatus 845. Also shown is the low-pressure valve 730 (V1 (LP)).

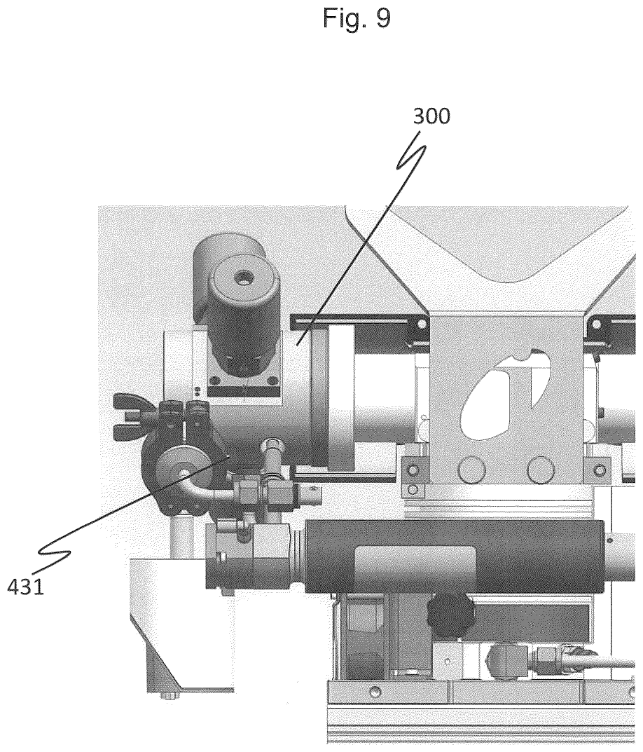

FIG. 9 illustrates longitudinal diagram exterior view of a gas inlet assembly 300 in accordance with one or more illustrative embodiments of the present disclosure. The external electrical heater (equivalently, heating element or heater) 315 connector (not visible) is visible installed in the heater receptacle 431. In an exemplary embodiment, the heater element is removably installed in a receptacle for easy field-maintenance and replacement. For example, the heater may be installed in a threaded bore hole machined into the gas inlet chassis so the thermal heat source is located at an optimized location in the body of the gas inlet chassis to affect the temperature gradient across the gas inlet chassis to regulate one or more gas path temperature(s) above the desired control setpoint(s) for optimized operation of the RGA.

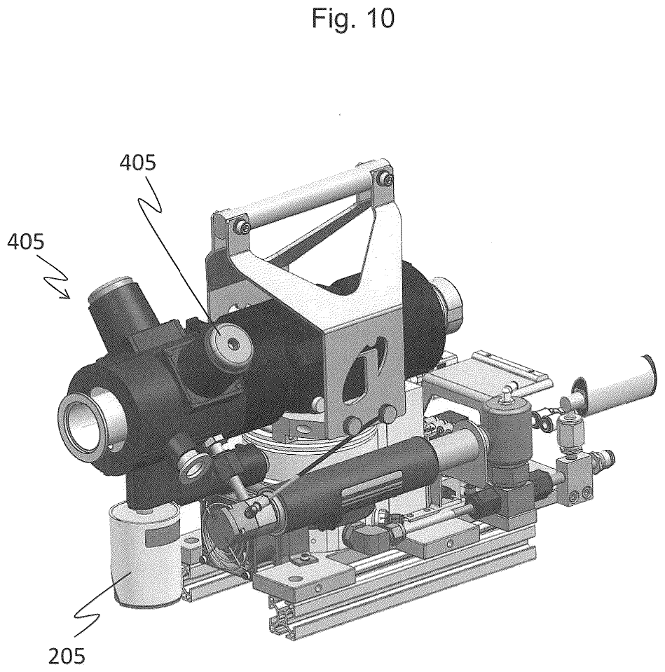

FIG. 10 illustrates a diagram of an exterior view of a residual gas analyzer manifold including a gas inlet assembly in accordance with one or more illustrative embodiments of the present disclosure. Two gas path valves 405 used to control gas flow along a plurality of gas paths are shown together with the process pressure gauge 205.

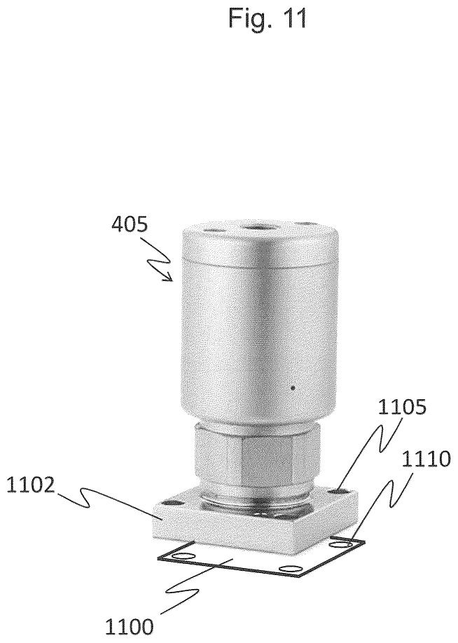

FIG. 11 illustrates a longitudinal view of a gas flow valve in accordance with one or more illustrative embodiments of the present disclosure. The gas flow valve 405 is removably attached to the gas inlet chassis (not shown) using a mounting flange 1102 and fasteners (not shown) disposed through flange mounting holes 1105. A bolt, washer and nut assembly as fasteners is specifically mentioned. A sealing gasket 1100 is disposed between the mounting flange 1102 and the gas inlet chassis (not shown) using gasket holes 1110 aligned with corresponding flange mounting holes 1105.

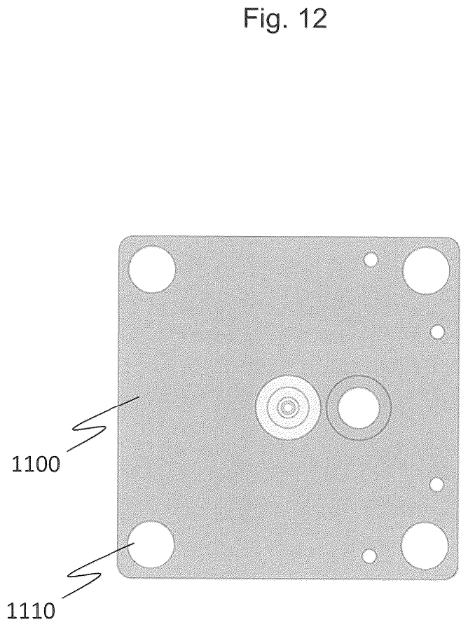

FIG. 12 illustrates a horizontal view of a gas flow valve gasket in accordance with one or more illustrative embodiments of the present disclosure. In an exemplary embodiment the sealing gasket 1100 is disposed between the gas valve mounting flange (not shown) and the gas inlet chassis (not shown) using gasket holes 1110 aligned with corresponding gas valve flange mounting holes 1105 in FIG. 11. The gasket may be comprised of any suitable compliant material suitable for the temperatures, pressures and environmental requirements (e.g., outgassing, durability, etc) for RGA applications. An elastomer material is specifically mentioned. A metal or metallic gasket is also specifically mentioned.

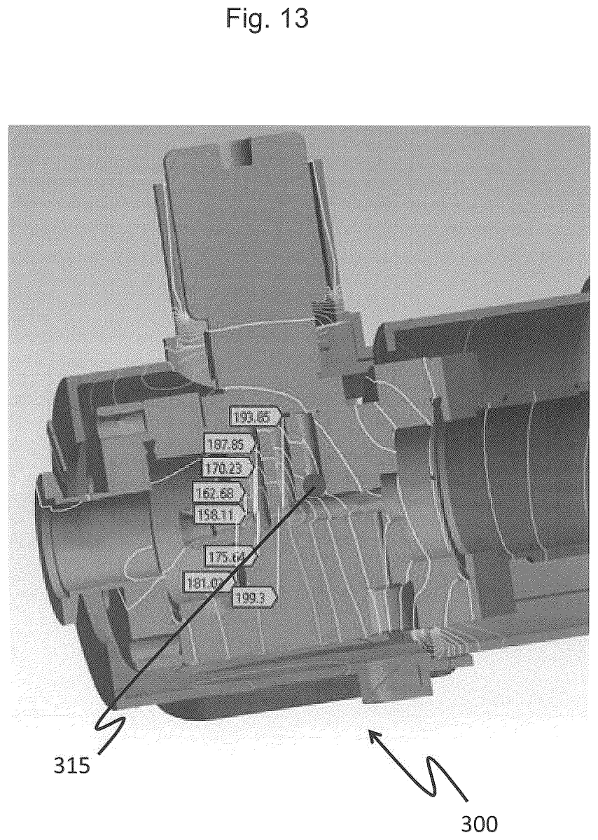

FIG. 13 shows a plot of simulated data for the temperature distribution in a longitudinal cross-sectional diagram of a gas inlet assembly comprising a heating element disposed in the gas inlet chassis in accordance with one or more illustrative embodiments of the present disclosure. The exemplary embodiment simulation displays contour lines of equal temperature along the thermal gradient in the equilibrium condition created by the heating element 315 disposed in the gas inlet chassis 300. Simulated results for the embodiment shown shows a temperature gradient is created by the heating element from approximately 188 degrees Centigrade (188° C.) near the heating element 315 to approximately 26 degrees Centigrade (26° C., about typical ambient room temperature) near the surface of the gas inlet chassis 300. Ambient temperatures at the surface of the gas inlet chassis are required for safe operation of the RGA when the heating element is in use.

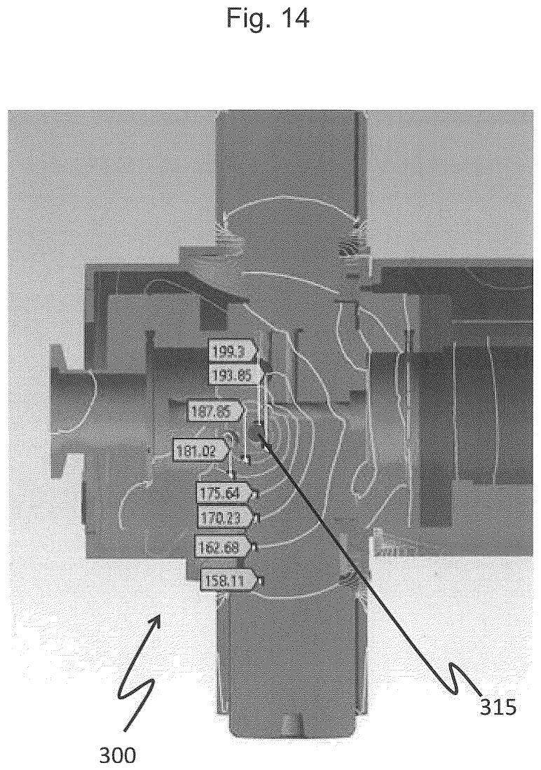

FIG. 14 shows a plot of simulated data for the temperature distribution in a horizontal cross-sectional diagram of a gas inlet assembly comprising a heating element disposed in the gas inlet chassis in accordance with one or more illustrative embodiments of the present disclosure. The exemplary embodiment simulation displays contour lines of equal temperature along the thermal gradient in the equilibrium condition created by the heating element 315 disposed in the gas inlet chassis 300. Simulated results for the embodiment shown shows a temperature gradient is created by the heating element from approximately 188 degrees Centigrade (188° C.) near the heating element 315. Temperature gradient contours show all the gas paths are maintained in a range between approximately 155 degrees Centigrade (188° C.) and 188 degrees Centigrade (188° C.) due to the optimized location of the heating element 315.

The present disclosure provides a means for controlled heating of sample gas to a residual gas analyzer through one or a plurality of gas paths designed for precision applications including, but not limited to, semiconductor and display fabrication processes. The approach is effective for reducing the formation of process byproducts that can condense in the inlet or on the sensor if the hot gas enters a cold gas inlet chassis that can lead to clogged flow paths or damage to sensors. The approach also readily adapts to sampling multiple process pressures with a single gas inlet attached to the gas inlet conduit and can accommodate one or a plurality of inline valves and flow-restrictive orifices attached or integrated into the gas inlet chassis. Temperature of the gas paths may be regulated by an electronic controller in electrical communication with a heater module fixed to the gas inlet chassis through a bored receptacle adjacent to the gas path(s).

Moreover, the disclosed invention obviates the need for external heating jackets that can exhibit cold spots due to poor thermal conductivity of steel and contain silicone rubber and adhesives that may outgas and create particulates that are problematic in a clean room environment.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

The disclosed system can alternately comprise, consist of, or consist essentially of, any appropriate components herein disclosed. The disclosed system can additionally be substantially free of any components or materials used in the prior art that are not necessary to the achievement of the function and/or objectives of the present disclosure.

The terms “a” and “an” do not denote a limitation of quantity, but rather denote the presence of at least one of the referenced item. The term “or” means “and/or” unless clearly indicated otherwise by context. Reference throughout the specification to “an embodiment”, “another embodiment”, “some embodiments”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments. “Optional” or “optionally” means that the subsequently described event or circumstance may or may not occur, and that the description includes instances where the event occurs and instances where it does not. The terms “first,” “second,” and the like, “primary,” “secondary,” and the like, as used herein do not denote any order, quantity, or importance, but rather are used to distinguish one element from another. The terms “front”, “back”, “bottom”, and/or “top” are used herein, unless otherwise noted, merely for convenience of description, and are not limited to any one position or spatial orientation.

The endpoints of all ranges directed to the same component or property are inclusive of the endpoints, are independently combinable, and include all intermediate points. For example, ranges of “up to 25 N/m, or more specifically 5 to 20 N/m” are inclusive of the endpoints and all intermediate values of the ranges of “5 to 25 N/m,” such as 10 to 23 N/m.

Unless defined otherwise, technical and scientific terms used herein have the same meaning as is commonly understood by one of skill in the art to which this invention belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

What is claimed is:

1. A gas inlet assembly, comprising:
a gas inlet chassis;
an inlet and an outlet disposed on said gas inlet chassis;
a plurality of gas paths connecting said inlet and said outlet;
at least one heating element thermally connected to the gas inlet chassis located such that a thermal distribution across the gas inlet chassis heats a gas flow through one or more gas paths.

2. The gas inlet assembly of claim 1, further comprising a low-pressure valve and a low-pressure gas path.

3. The gas inlet assembly of claim 1, further comprising a high-pressure valve and a high-pressure gas path.

4. The gas inlet assembly of claim 1, further comprising a high conductance valve and a high conductance gas path.

5. The gas inlet assembly of claim 1, further comprising a bypass pressure valve and a bypass pressure gas path.

6. The gas inlet assembly of claim 1, further comprising a calibration gas connection, a calibration pressure valve, and a calibration gas path.

7. The gas inlet assembly of claim 1, wherein the gas flow through at least one gas path is controlled by a valve disposed along said gas path.

8. The gas inlet assembly of claim 1, further comprising an electrical heating element proximal to at least one gas path.

9. The gas inlet assembly of claim 1, further comprising a sensor disposed in contact with the gas inlet chassis and a controller to maintain a temperature of the gas flow through at least one gas path above a temperature setpoint.

10. The gas inlet assembly of claim 1, wherein the gas inlet assembly is detachably disposed on an exterior surface of a mass spectrometer using a gasket and seals said mass spectrometer in fluidic communication to a process inlet conduct.

11. The gas inlet assembly of claim 1, wherein the gas inlet assembly is detachably disposed on an exterior surface of a mass spectrometer using a flange and a gasket rigidly attached using at least one fastener.

12. The gas inlet assembly of claim 1, wherein the gas inlet assembly is detachably disposed on an exterior surface of a process inlet conduit using a flange and a seal rigidly attached using at least one fastener.

13. A residual gas analyzer comprising:
a mass spectrometer;
a process gas inlet conduit;
a gas inlet chassis sealingly disposed between said mass spectrometer and an end of said process gas inlet conduit;
wherein said gas inlet chassis comprises at least one heating element and a plurality of gas paths disposed between an inlet and an outlet; and
wherein the at least one heating element is thermally connected to the gas inlet chassis and located such that a thermal distribution across the gas inlet chassis heats a gas flow through one or more of the plurality of gas paths.

14. A method for providing heated gas to a mass spectrometer comprising:
providing a gas inlet chassis comprising a heating element and a plurality of gas paths disposed between an inlet and an outlet;
directing a stream of gas under pressure into said inlet;
directing an electrical current through a conduit into the heating element to generate a temperature gradient across the gas inlet chassis to heat the stream of gas;
directing the heated stream of gas through said outlet into the mass spectrometer.

15. The method of claim 14, wherein the gas flow through at least one of the plurality of gas paths is controlled by adjusting a valve disposed along said gas path.

16. The method of claim 14, wherein said mass spectrometer is a quadrupole mass spectrometer.
